(19) United States
(12) Patent Application Publication
(10) Pub. No.: US 2025/0077923 A1
(43) Pub. Date: Mar. 6, 2025

(54) SYSTEMS AND METHODS FOR SIGNAL ANALYSIS-SYNTHESIS AND COMPRESSION USING QUANTUM FOURIER TRANSFORM

(71) Applicants: Andreas Spanias, Tempe, AZ (US); Aradhita Sharma, Tempe, AZ (US); Leslie Miller, Rendondo Beach, CA (US); Glen Uehara, Gilbert, AZ (US)

(72) Inventors: Andreas Spanias, Tempe, AZ (US); Aradhita Sharma, Tempe, AZ (US); Leslie Miller, Rendondo Beach, CA (US); Glen Uehara, Gilbert, AZ (US)

(73) Assignee: Arizona Board of Regents on Behalf of Arizona State University, Tempe, AZ (US)

(21) Appl. No.: 18/752,591

(22) Filed: Jun. 24, 2024

Related U.S. Application Data
(60) Provisional application No. 63/509,983, filed on Jun. 23, 2023.

(51) Int. Cl. G06N 10/20; G06N 10/60

(52) U.S. Cl. CPC G06N 10/20; G06N 10/60

(57) ABSTRACT

Quantum circuits for QFT and Inverse QFT (IQFT) are disclosed that can be applied for use in signal and speech, analysis synthesis and compression. A unique method perceptual selection of QFT components is also outlined.

### CROSS REFERENCE TO RELATED APPLICATIONS

This is a non-provisional application that claims benefit to U.S. Provisional Application Ser. No. 63/509,983, filed on Jun. 23, 2023, which is herein incorporated by reference in its entirety.

### GOVERNMENT SUPPORT

This invention was made with government support under 2215998 awarded by the National Science Foundation. The government has certain rights in the invention.

### FIELD

The present disclosure generally relates to tools for signal analysis-synthesis and compression, and in particular, to a system and associated method for quantum circuits for Quantum Fourier transform (QFT) and Inverse QFT (IQFT) for use in signal and speech, analysis synthesis and compression.

### BACKGROUND

Quantum computing (QC) promises to process data with estimated speeds exceeding 100 million times relative to classical computers. Signal processing is one field involving computationally expensive methods that are commonly affected by conventional hardware limitations.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is a diagram showing a QFT circuit for 3 qubits after measurement;

FIG. 2 is a diagram showing an IQFT circuit for 3 qubits after measurement;

FIG. 3 is a simplified block diagram showing J-DSP Signal analysis-synthesis for the QFT circuit of FIG. 1 and the IQFT circuit of FIG. 2;

FIG. 4 is a simplified block diagram showing QFT-based simulation including quantum noise effects;

FIG. 5 is a screenshot showing simulation of a framework implementing Psychoacoustics in FFT-based analysis-synthesis;

FIG. 6 is a diagram showing a flow of one implementation of perceptual QFT-based signal analysis-synthesis using perceptual picking;

FIG. 7 is a block diagram showing J-DSP Perceptual QFT-based signal analysis synthesis using perceptual selection; and

FIG. 8 is a simplified diagram showing an exemplary computing system for implementation of systems outlined herein.

Corresponding reference characters indicate corresponding elements among the view of the drawings. The headings used in the figures do not limit the scope of the claims.

### DETAILED DESCRIPTION

The present disclosure outlines development of Quantum Fourier transform (QFT) tools for signal analysis-synthesis and compression. More specifically, the present disclosure shows quantum circuits for QFT and Inverse QFT (IQFT) for use signal and speech, analysis synthesis and compression. We examine QFT resolution, precision in terms of qubits, and provide simple tools to measure the effects of quantum measurement noise. In this study, we also describe a simulation on QFT-based speech analysis-synthesis which we profile in terms of performance and complexity. We also provide a unique method for perceptual selection of QFT components. We provide technical details below.

The present disclosure outlines the following contributions:
QFT based circuits designed for signal analysis-synthesis
A quantum system is presented for signal compression via peak-picking of QFT components
A quantum system is presented for signal compression via perceptual selection of QFT components
Selecting QFT components above the masking threshold for compression.
Models for Noise characterization in the QFT compression scheme are selected.
   The Quantum Fourier transform

QFT can be viewed as the quantum realization of the discrete Fourier transform (DFT). Consider a state vector |ψ [symbol] =Σₙ₌₀^{N-1}hₙ|n [symbol] which represents the signal, where hₙ are the amplitudes associated with N basis states |n [symbol] . The binary expression of qubits is expressed as

$$n = {n}_{0} {2}^{0} + {n}_{1} {2}^{1} + {n}_{2} {2}^{2} + … + {n}_{m - 1} {2}^{m - 1} \qquad ( 1 )$$

where m is the number of qubits forming an N=2^{m} dimensional system. Fractional and integral terms can be written exponentially as

$${e}^{\frac{2 π in}{{2}^{k}}} = {e}^{2 π i ( \frac{{n}_{0}}{{2}^{k}} + … + \frac{{n}_{k - 1}}{2} ) + 2 π i ( {n}_{k} + … + {n}_{m - 1} {2}^{m - k - 1} )} \qquad ( 2 )$$

The integral part corresponding to

$${e}^{\frac{2 π in}{{2}^{k}}}$$

is equal to 1. Hence, the equation can be written as product of k factors as

$${e}^{\frac{2 π in}{{2}^{k}}} = {e}^{2 π i ( \frac{{n}_{0}}{{2}^{k}} )} \cdot {e}^{2 π i ( \frac{{n}_{1}}{{2}^{k - 1}} )} … {e}^{2 π i ( \frac{{n}_{k - 1}}{2} )} \qquad ( 3 )$$

The quantum Fourier transform for the |ψ [symbol] state can be written as

$$QFT \vert ψ 〉 \to {\sum }_{n = 0}^{N - 1} {b}_{k} \vert k 〉 \qquad ( 4 )$$

$$where ,$$

$${b}_{k} = \frac{1}{\sqrt{N}} {\sum }_{n = 0}^{N - 1} {h}_{n} \cdot {e}^{2 π ikn / N} \qquad ( 5 )$$

The binary representation is given by |k [symbol] =|nₘ₋₁ . . . n₁n₀ [symbol] . Writing the QFT for |n [symbol] basis state in binary representation gives

$$QFT \vert ψ 〉 \to \frac{1}{\sqrt{N}} {\sum }_{k = 0}^{N - 1} {\sum }_{n = 0}^{N - 1} {h}_{n} \cdot {e}^{2 π ikn / N} \vert {n}_{m - 1} … {n}_{1} {n}_{0} 〉 \qquad ( 6 )$$

where,

$$\frac{1}{\sqrt{N}}$$

is the normalizing factor. Considering |n [symbol] state of the |ψ [symbol] =Σₙ₌₀^{N-1}hₙ|n [symbol] , and calculating its QFT gives us

$$QFT \vert n 〉 \to \frac{1}{\sqrt{N}} {\sum }_{k = 0}^{N - 1} {e}^{2 π ikn / N} \vert {n}_{m - 1} ... {n}_{1} {n}_{0} 〉 \qquad ( 7 )$$

Eq. (7) is similar to DFT with the opposite sign of the phase exponent. Writing the equation as tensor products of qubit's basis states to represent QFT in a compact manner (i.e., in terms of tensor products of qubit's basis states), that is,

$$QFT \vert n 〉 \to \frac{1}{\sqrt{{2}^{m}}} ( \vert 0 〉 + {e}^{2 π {in}_{0}} \vert 1 〉 ) ⊗ ( \vert 0 〉 + {e}^{2 π {in}_{0} {n}_{1}} \vert 1 〉 ) ... ... ⊗ ( \vert 0 〉 + {e}^{2 π {in}_{0} {n}_{1} ... {n}_{m - 1}} \vert 1 〉 ) \qquad ( 8 )$$

This tensor product state is obtained using the controlled rotation of the basis states in superposition. Basis states can be expressed as a tensor product that enables unitary transform implementations for creating a quantum circuit. The IQFT is given by

$$IQFT \vert n 〉 \to \frac{1}{\sqrt{N}} {\sum }_{k = 0}^{N - 1} {e}^{2 π ikn / N} \vert {k}_{m - 1} ... {k}_{1} {k}_{0} 〉 \qquad ( 9 )$$

### QFT/IQFT Circuit Design

### QFT Circuit

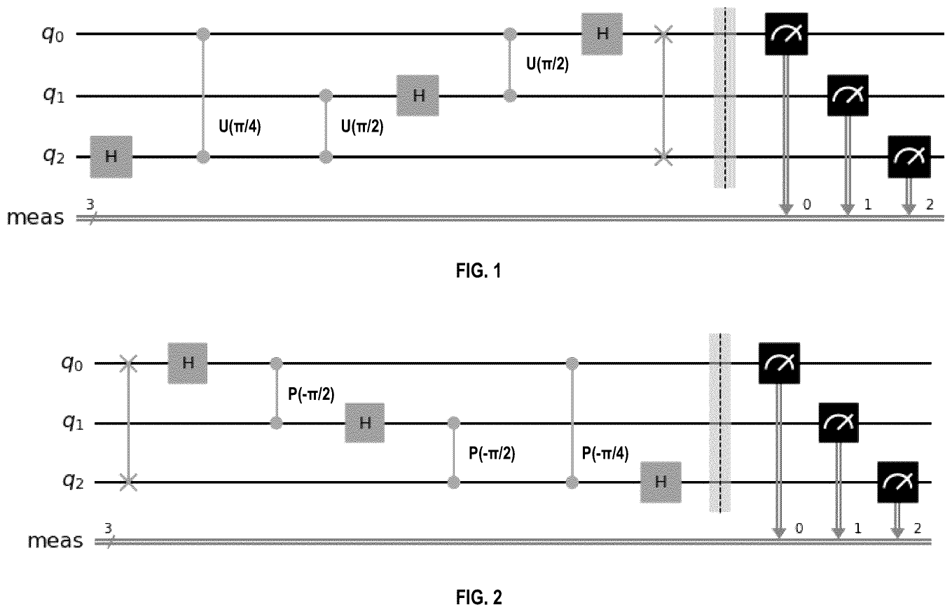

For implementation of the QFT, a circuit shown in FIG. 1 can be constructed using single-qubit “H” gates, a two-qubit “R” gate (represented with purple lines between qubits as ∪ (angle of rotation)), and a SWAP gate (represented as a blue line). The gates are separated by measurement blocks (black) using a barrier (gray line) at an output of the circuit.

A QFT circuit shown in FIG. 1 includes: a first qubit q₀, a second qubit q₁, and a third qubit q₂; a first single-qubit “H” gate that receives a value of the third qubit q₂; a first two-qubit “R” gate connecting an output of the first single-qubit “H” gate with the first qubit q₀; a second two-qubit “R” gate connecting the second qubit q₁ with an output of the first two-qubit “R” gate associated with the third qubit q₂; a second single-qubit “H” gate at an output of the second two-qubit “R” gate associated with the second qubit q₁; a third two-qubit “R” gate connecting an output of the second single-qubit “H” gate with an output of the first two-qubit “R” gate associated with the first qubit q₀; a third single-qubit “H” gate at an output of the third two-qubit “R” gate associated with the first qubit q₀; and a SWAP gate connecting the output of the third single-qubit “H” gate with the output of the second two-qubit “R” gate associated with the third qubit q₂. The first two-qubit “R” gate can have an angle of π/4, the second two-qubit “R” gate can have an angle of π/2, and the third two-qubit “R” gate can have an angle of π/2

The quantum circuit can further include a first measurement block associated with a final output of the first qubit q₀; a second measurement block associated with a final output of the second qubit q₁; and a third measurement block associated with a final output of the third qubit q₂.

The values of the first qubit q₀, the second qubit q₁, and the third qubit q₂ are associated with an input signal and where an output of the first qubit q₀, the second qubit q₁, and the third qubit q₂ are associated with a transformed signal of a quantum Fourier transform that corresponds to the input signal.

It is seen that a total of

$$\frac{m ( m + 1 )}{2}$$

H and R, at must m/2 SWAP gates are required for the QFT circuit. Hence, the complexity is 0 (m²) where m is the number of qubits. An exponential speedup is observed in the QFT due to quantum parallelism achieved by the entanglement and superposition property.

### IQFT Circuit

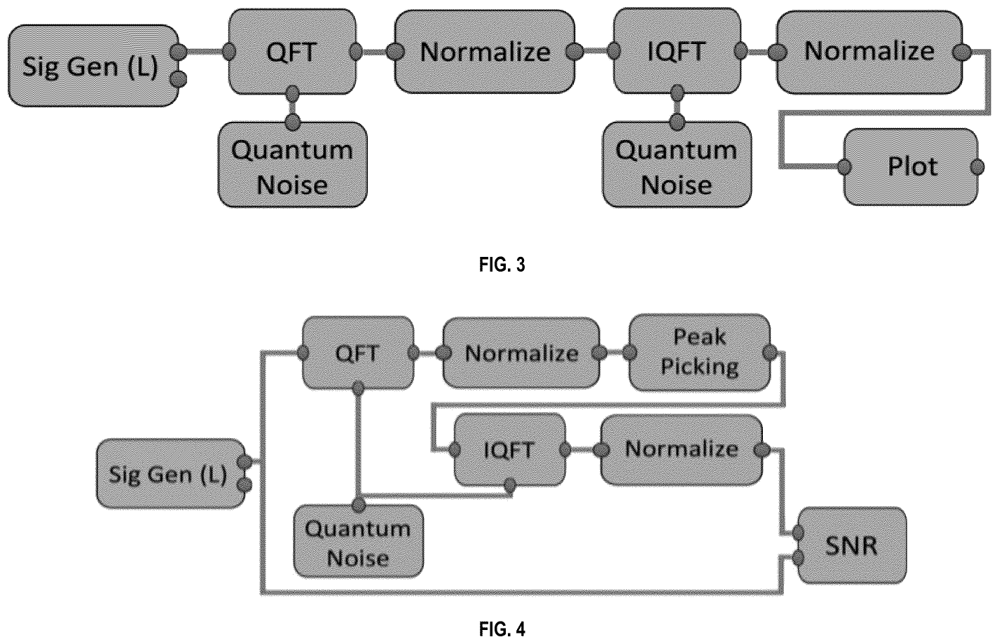

The 3-qubit IQFT circuit can be developed by modifying the QFT as shown in FIG. 2. An IQFT circuit shown in FIG. 2 includes: a first qubit q₀, a second qubit q₁, and a third qubit q₂; a SWAP gate connecting the first qubit q₀ with the third qubit q₂; a first single-qubit “H” gate at an output of the SWAP gate associated with the first qubit q₀; a first two-qubit “R” gate connecting an output of the first single-qubit “H” gate with the second qubit q₁; a second single-qubit “H” gate at an output of the first two-qubit “R” gate associated with the second qubit q₁; a second two-qubit “R” gate connecting an output of the second single-qubit “H” gate with the third qubit q₂; a third two-qubit “R” gate connecting an output of the first two-qubit “R” gate associated with the first qubit q₀ with an output of the second two-qubit “R” gate associated with the third qubit q₂; and a third single-qubit “H” gate at an output of the third two-qubit “R” gate associated with the third qubit q₂. The first two-qubit “R” gate can have an angle of (−π/2), the second two-qubit “R” gate can have an angle of (−π/2), and the third two-qubit “R” gate can have angle of (−π/4).

The quantum circuit can further include a first measurement block associated with a final output of the first qubit q₀; a second measurement block associated with a final output of the second qubit q₁; and a third measurement block associated with a final output of the third qubit q₂.

The values of the first qubit q₀, the second qubit q₁, and the third qubit q₂ can be associated with a transformed signal and where an output of the first qubit q₀, the second qubit q₁, and the third qubit q₂ are associated with a reconstructed signal of an inverse quantum Fourier transform that corresponds to the input signal.

### Quantum Noise Models

Quantum computers are susceptible to noise from various sources such as external environmental interactions, crosstalk caused by the neighboring qubits when excited by lasers, and quantum implementation errors. To consider how the algorithm will behave in real devices, quantum error models are introduced to perform noisy simulations. We use three types of quantum errors which represent the effect of decoherence on qubits. They are, namely:
Amplitude damping channel, which occurs as an effect of energy dissipation from the quantum system.
Phase damping channel, represents the loss of partial information from quantum relative phases.
Measurement error, occurs during the final state and measures the output that differs by 1 bit, or 2 bits.
   Quantum Preprocessing: Normalization for quantum encoding

To process speech signals using quantum computing, the signal needs to be encoded in the quantum domain. The quantum encoding of a speech signal requires the normalization of the speech signal in such a way that the square of all the probability amplitudes sum up to 1 (|α₁|²+|α₂|² + . . . +|αₙ|²=1, where an are the input signal values). Therefore, the input speech is normalized with the norm factor.

$$Norm = \sqrt{{\vert {a}_{1} \vert}^{2} + {\vert {a}_{2} \vert}^{2} + … + {\vert {a}_{n} \vert}^{2} = 1} \qquad ( 10 )$$

The quantum encoded signal represented as the quantum state has the wavefunction values as αₙ/Norm.

### Quantum Postprocessing: De-Normalization for Quantum Synthesis

After the quantum circuit is executed, a measurement is performed on the set of qubits, and these measurement outputs are represented as the probabilities indicating the likelihood of obtaining a particular measurement result. De-normalization of this measurement result is necessary to facilitate analysis of the obtained results and to perform quantum synthesis of the speech signals at the end. The quantum synthesized result at the end is expressed as ρₙ*Norm, where ρₙ is the obtained probability values at the end.

### QFT for Speech Signals

The obtained quantum state after the performing the QFT circuit computation is

$$QFT \vert ψ 〉 = {p}_{0} \vert {n}_{0} 〉 + {p}_{1} \vert {n}_{1} 〉 + … + {p}_{N - 1} \vert {n}_{N - 1} 〉 \qquad ( 11 )$$

where pₖ is the wavefunction value, and pₖ² corresponds to the probabilistic values which will be obtained after performing quantum measurement. Since after the measurement, the probability values are obtained only, therefore, there is a need to modify the results for speech processing and make it comparable to classical FFT output. For obtaining the QFT coefficients for the speech signals, the final QFT coefficients are represented in Euler's form including the probability values and the phase information obtained from the wavefunction, where Im and Re are the imaginary and real parts of pₖ:

$${QFT}_{k} = \sqrt{{{p}_{k}}^{2}} \cdot {e}^{{itan}^{- 1} ( \frac{Im ( {p}_{k} )}{Re ( {p}_{k} )} )} \qquad ( 12 )$$

After this result, the QFT coefficients are normalized using the norm factor and the scaling factor \sqrt{2^{m}} to make these coefficients comparable to the classical coefficients for speech processing functions.

$${QFT}_{k} = {QFT}_{k} * ( norm * \sqrt{{2}^{m}} ) \qquad ( 13 )$$

### IQFT for Speech Signals

Similar to the QFT, when the IQFT circuit is measured, the obtained results are modified using the equation (12). And after this result, the IQFT coefficients are normalized using the norm factor and the scaling factor \sqrt{2^{m}} to make these coefficients comparable to the classical coefficients for quantum speech synthesis.

$${IQFT}_{k} = {IQFT}_{k} * ( norm * \sqrt{{2}^{m}} ) \qquad ( 14 )$$

### Signal Analysis-Synthesis Using the QFT and IQFT

We can analyze the signal in the quantum domain by decomposing it into its quantum components obtained through the QFT function. Quantum noise can be added to observe the effects on the QFT algorithm. Similarly, the IQFT is used to synthesize an input signal based on a captured signal and the time domain values are computed. The signal analysis-synthesis block diagram without peak-picking is shown in FIG. 3.

### QFT and DFT Performance With Noise

In QFT and IQFT computation, quantum noise affects the spectral output. Because of quantum noise, the QFT spectrum components are not as precise as those obtained using the DFT. To compare QFT and DFT numerical output, we evaluate the magnitude difference between QFT and DFT coefficients. Comparative spectral estimation simulations were run with sinusoidal and speech segments. For this simulation, a quantum noise model with 20% amplitude damping was introduced which affected the values of the quantum basis states. After we obtained the spectra for 256 frame-size speech segments, we compared the DFT and QFT components. Table 1 provides the percentage magnitude difference as a function of the number of qubits for the QFT. The error is calculated by

$$Error ( \% ) = \frac{avg ( abs ( QFT ) - abs ( DFT ) )}{avg ( abs ( DFT ) )} * 100 \qquad ( 15 )$$

We observe that as the number of qubits increases, the error increases due to quantum noise. We note that in our sinusoidal signal simulations, we did not observe a change in the frequency estimate-only in the magnitude and phase.

TABLE 1
Percentage Magnitude Difference between QFT and DFT.

| | | | | | | | |
|---|---|---|---|---|---|---|---|
| DFT | 16 | 32 | 64 | 128 | 256 | 512 | 1024 |
| Resolution | | | | | | | |
| QFT bits | 4 | 5 | 6 | 7 | 8 | 9 | 10 |
| Error (%) | 4.91 | 6.64 | 7.67 | 8.33 | 10.01 | 15.45 | 22.99 |

### QFT Simulation Using J-DSP

A system and simulation framework shown in FIG. 4 was developed for speech analysis-synthesis. This is used to and compare the behavior of the QFT and classical DFT for a signal analysis-synthesis task.

The simulation uses spectral peak-picking. We note that perceptual audio analysis was used in several audio compression applications. The simulation provides options to change the parameters of QFT signal analysis-synthesis and quantum noise. The input (speech) signal can be generated from a signal generator block, which is given as an input to the QFT function to analyze the quantum components of the signal in presence of quantum noise. The QFT output is normalized to be in the frequency domain range. For signal compression, the first L or highest L components (peaks) are selected where L depends on the desired compression ratio; the rest of the components are set to zero. This modified input is passed on to the IQFT function (with quantum noise) to reconstruct the signal. Normalization is performed to scale the reconstructed signal. At the end, the Signal-to-Noise Ratio (SNR) is calculated to compare the original and the reconstructed quantum-based signal as shown in FIG. 4. The result is compared with the signal compression approach using classical DFT-based computation. Selecting the highest components of the frequency domain maximizes the SNR. As expected, the SNR increases as the number of selected components (L) is increased. It is also noticed that the SNR for quantum computation is less than that of the SNR for classical FFT. This difference increases with an increasing number of qubits because of quantum noise effects. Through this simulation we are able to evaluate the performance of QFT/IQFT, peak-picking processes, transform-based signal compression, and quantum noise effects.

### Perceptual Models and QFT Simulation

We developed a unique QFT compression model that is based on perceptual criteria. In this model, the QFT components are selected based on the JND curve.

Perceptual selection is the process of determining which frequency components of a signal are most pertinent or perceptually significant to human hearing. This selection process is often employed in audio coding and compression algorithms, where the goal is to reduce the amount of data without sacrificing perceived audio quality. Psychoacoustic models are used to estimate the audibility or perceptual importance of specific frequency components based on various psychoacoustic principles.

The human ear has a limited range of audible frequencies, typically ranging from approximately 20 Hz to 20 KHz. This range is commonly referred to as the audible frequency range. These sounds are typically not perceived or heard by the average human ear. The human ear has a minimum sound pressure level (SPL) that is required for sounds to be perceptible. This minimum SPL is known as the threshold of hearing and represents the lowest level at which a sound can be detected by the average human ear. The equation below represents the threshold of hearing.

$$T ( f ) = 3.64 {( \frac{f}{1000} )}^{- 0.8} - 6.5 {e}^{- 0.6 {( \frac{f}{1000} - 3.3 )}^{2} + 0.001 {( \frac{f}{1000} )}^{4}} \qquad ( 16 )$$

where T(f) represents the threshold of hearing at frequency f in dB SPL (Sound Pressure Level) and f is the frequency in Hz. If a sound has a pressure level below the absolute threshold of hearing, it will not be perceived or heard by the individual, regardless of whether it falls within the frequency range of the human ear. The threshold of hearing varies with frequency, and different frequencies have different sensitivity levels.

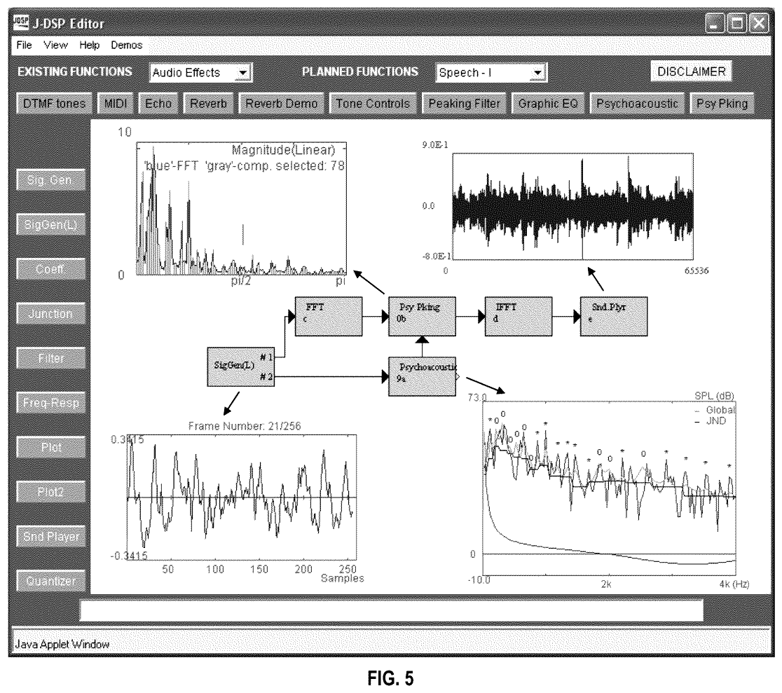

The psychoacoustic model determines the maximum allowable quantization noise level in each critical band so that COMPRESSION noise remains inaudible. For the perceptual coding algorithm, the psychoacoustic model uses a 512-point FFT for spectral analysis of the windowed input signal, and then estimates individual simultaneous masking thresholds due to the presence of tone-like and noise-like maskers in the signal spectrum. A global masking threshold is then estimated by the additive combination of the tonal and non-tonal individual masking thresholds. Finally, the just noticeable distortion and the signal-to-mask ratio are calculated. We showed before that a DFT-based peak-picking algorithm can be used for signal compression. In this section, we revisit this algorithm but instead of peak-picking the DFT, we use psychoacoustics to select the DFT and QFT components to be used for efficient signal synthesis. An FFT-based perceptual audio synthesis algorithm that uses psychoacoustic principles is described here. The criteria used for FFT component selection is formed using global masking thresholds or the JND curve. Spectral components above the JND level can be considered as perceptible while those falling below that level can be considered as perceptually irrelevant. The IFFT is then used to reconstruct the audio signal, which is then played back and evaluated. An image showing the simulation implemented in J-DSP is shown below in FIG. 5.

The time-domain signal is shown in the bottom left panel of FIG. 5. The global masking threshold, the FFT magnitude, and the JND curve are shown in the bottom right panel of FIG. 5. The FFT magnitude components that fall above the JND curve are selected for signal synthesis while the rest of the FFT components are set to zero. The IFFT is used to convert the signal to the time domain. The entire signal is processed frame-by-frame. For the QFT and IQFT a similar perceptual component section is developed.

### Quantum Preprocessing: Normalization for Perceptual Selection

When performing perceptual QFT-based signal analysis synthesis, the global masking threshold and the JND curve is calculated to obtain the perceptual significance of the signal spectral components, and the components above the JND curve are perceptually significant and hence are selected. Since the selection of components is based upon the JND curve value, which is different from the peak picking selection, the normalization and de-normalization performed for this method are performed with respect to the JND curve.

### Perceptual QFT Based Analysis Synthesis Using Perceptual QFT Selection

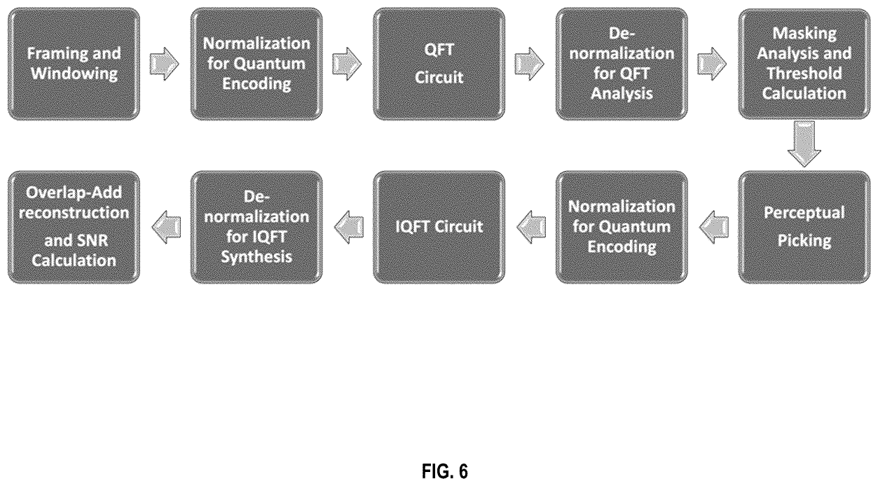

Perceptual selection is the process of determining which frequency components of a signal are most pertinent or perceptually significant to human hearing. This selection process is often employed in audio coding and compression algorithms, where the goal is to reduce the amount of data without sacrificing perceived audio quality. Psychoacoustic models are used to estimate the audibility or perceptual importance of specific frequency components based on various psychoacoustic principles. Motivated by this approach, this research focuses on implementing signal analysis synthesis using perceptual selection technique in the context of quantum computing. The process shown in FIG. 6 involves the following steps:

Framing and Windowing: The speech signal is preprocessed by dividing the signal into frame segments with 50% overlapping to avoid information loss at the frame boundaries and windowing is performed with a triangular window to ensure smooth transitions at the edges of the frame signal.

Normalization for quantum encoding: Normalization is performed on the windowed frame signal such that the signal is encoded to be represented as a quantum state. The normalization factor is calculated as

$$Norm = {\vert {α}_{1} \vert}^{2} + {\vert {α}_{2} \vert}^{2} + … + {\vert {α}_{n} \vert}^{2}$$

where αₙ are the input signal values. The quantum encoded signal has the wavefunction values as αₙ/Norm.

QFT analysis: QFT is applied to the quantum-encoded signal frame and post-measurement, the QFT coefficients are calculated from the probability values.

De-normalization for quantum analysis: The quantum state is de-normalized which results in a set of QFT coefficients as

$${QFT}_{n} = {QFT}_{n} * ( norm * \sqrt{{2}^{m}} )$$

Masking Analysis and Threshold Calculation: The masking effect between different frequency components is analyzed to determine their perceptual significance. individual simultaneous masking thresholds due to the presence of tone-like and noise-like maskers in the signal spectrum are calculated. A global masking threshold is then estimated by the additive combination of the tonal and non-tonal individual masking thresholds and a JND (Just Noticeable Difference) curve is obtained.

Perceptual Selection: The magnitude of the QFT components is compared with the corresponding masking threshold. The components above the masking threshold of the JND curve are considered perceptually significant and hence are selected, and the remaining components are discarded.

Normalization for quantum encoding: The selected perceptual QFT coefficients are normalized and quantum encoded for further quantum computation.

IQFT synthesis: The normalized coefficients are used as input to the IQFT circuit which reconstructs the compressed frame signal from the selected coefficients.

De-normalization for quantum synthesis: The reconstructed frame signal is then de-normalized to ensure that its values fall within the desired range. This step is important to maintain the overall amplitude and dynamic range of the original signal.

$${IQFT}_{n} = {IQFT}_{n} * ( norm / \sqrt{{2}^{m}} )$$

Overlap-Add Method: The de-normalized frames are merged using the OLA method to obtain the compressed reconstructed signal.

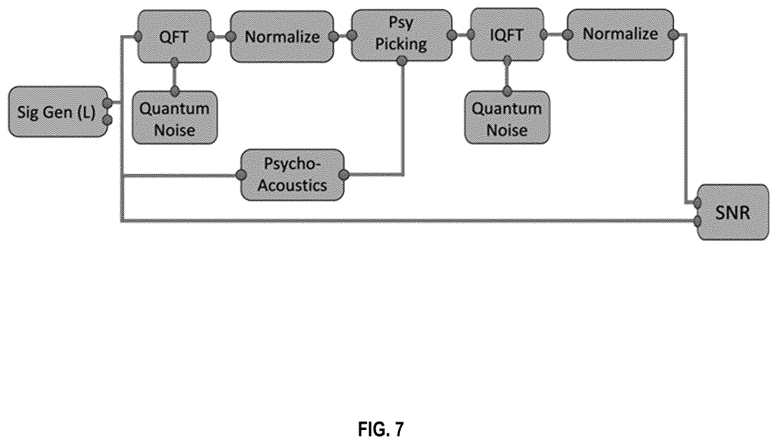

When using perceptually selected QFT reconstruction, the discarded QFT components are intentionally omitted, as they are considered to have minimal perceptual impact. As a result, comparing the reconstructed signal with the original signal in terms of Signal-to-Noise Ratio (SNR) may not provide meaningful information. Therefore, for evaluating perceptually selected FFT reconstruction methods, this research conducted listening tests involving different individuals, relying on human perception to assess the quality of the reconstructed signal, and individuals marked similar quality for both QFT-based and DFT-based reconstructed signals. The J-DSP representation of perceptual QFT-based analysis synthesis using perceptual QFT selection is shown in FIG. 7.

### Computer-Implemented System

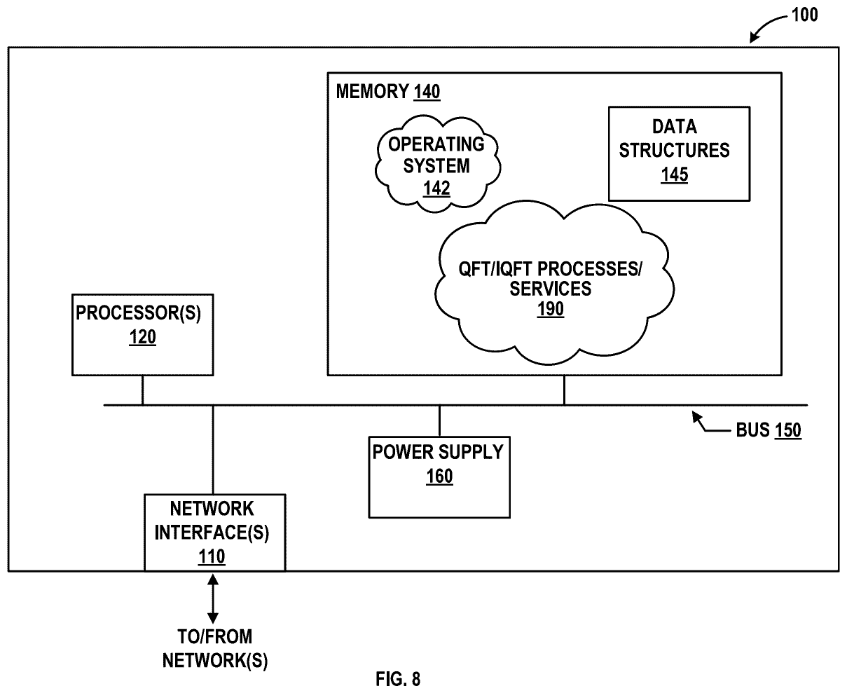

FIG. 8 is a schematic block diagram of an example device 100 that may be used with one or more embodiments described herein.

Device 100 comprises one or more network interfaces 110 (e.g., wired, wireless, PLC, etc.), at least one processor 120, and a memory 140 interconnected by a system bus 150, as well as a power supply 160 (e.g., battery, plug-in, etc.).

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, device 100 may have limited memory or no memory (e.g., no memory for storage other than for programs/processes operating on the device and associated caches). Memory 140 can include instructions executable by the processor 120 that, when executed by the processor 120, cause the processor 120 to implement aspects of the systems and the methods outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes device 100 by, inter alia, invoking operations in support of software processes and/or services executing on the device. These software processes and/or services may include QFT/IQFT processes/services 190, which can include aspects of methods and/or implementations of various modules described herein. Note that while QFT/IQFT processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the QFT/IQFT processes/services 190 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A quantum circuit, comprising:
a first qubit q₀, a second qubit q₁, and a third qubit q₂;
a first single-qubit “H” gate that receives a value of the third qubit q₂;
a first two-qubit “R” gate connecting an output of the first single-qubit “H” gate with the first qubit q₀;
a second two-qubit “R” gate connecting the second qubit q₁ with an output of the first two-qubit “R” gate associated with the third qubit q₂;
a second single-qubit “H” gate at an output of the second two-qubit “R” gate associated with the second qubit q₁;
a third two-qubit “R” gate connecting an output of the second single-qubit “H” gate with an output of the first two-qubit “R” gate associated with the first qubit q₀;
a third single-qubit “H” gate at an output of the third two-qubit “R” gate associated with the first qubit q₀; and
a SWAP gate connecting the output of the third single-qubit “H” gate with the output of the second two-qubit “R” gate associated with the third qubit q₂.

2. The quantum circuit of claim 1, further comprising:
a first measurement block associated with a final output of the first qubit q₀;
a second measurement block associated with a final output of the second qubit q₁; and
a third measurement block associated with a final output of the third qubit q₂.

3. The quantum circuit of claim 1, the first two-qubit “R” gate having an angle of π/4, the second two-qubit “R” gate having an angle of π/2, and the third two-qubit “R” gate having an angle of π/2.

4. The quantum circuit of claim 1, where values of the first qubit q₀, the second qubit q₁, and the third qubit q₂ are associated with an input signal and where an output of the first qubit q₀, the second qubit q₁, and the third qubit q₂ are associated with a transformed signal of a quantum Fourier transform that corresponds to the input signal.

5. A quantum circuit, comprising:
a first qubit q₀, a second qubit q₁, and a third qubit q₂;
a SWAP gate connecting the first qubit q₀ with the third qubit q₂;
a first single-qubit “H” gate at an output of the SWAP gate associated with the first qubit q₀;
a first two-qubit “R” gate connecting an output of the first single-qubit “H” gate with the second qubit q₁;
a second single-qubit “H” gate at an output of the first two-qubit “R” gate associated with the second qubit q₁;
a second two-qubit “R” gate connecting an output of the second single-qubit “H” gate with the third qubit q₂;
a third two-qubit “R” gate connecting an output of the first two-qubit “R” gate associated with the first qubit q₀ with an output of the second two-qubit “R” gate associated with the third qubit q₂; and
a third single-qubit “H” gate at an output of the third two-qubit “R” gate associated with the third qubit q₂.

6. The quantum circuit of claim 5, further comprising:
a first measurement block associated with a final output of the first qubit q₀;
a second measurement block associated with a final output of the second qubit q₁; and
a third measurement block associated with a final output of the third qubit q₂.

7. The quantum circuit of claim 5, the first two-qubit “R” gate having an angle of (−π/2), the second two-qubit “R” gate having an angle of (−π/2), and the third two-qubit “R” gate having an angle of (−π/4).

8. The quantum circuit of claim 5, where values of the first qubit q₀, the second qubit q₁, and the third qubit q₂ are associated with a transformed signal and where an output of the first qubit q₀, the second qubit q₁, and the third qubit q₂are associated with a reconstructed signal of an inverse quantum Fourier transform that corresponds to the input signal.

9. A quantum system for signal compression by perceptual selection of QFT components, comprising:
a processor in communication with a memory, one or more QFT circuits, and one or more IQFT circuits, the memory including instructions executable by the processor to:
access, at the processor, an input signal;
apply the input signal to the one or more QFT circuits to obtain a transformed signal and quantum noise information associated with the input signal; and
apply the transformed signal to the one or more IQFT circuits to obtain a reconstructed signal and quantum noise information associated with the transformed signal.

10. The quantum system of claim 9, the memory including instructions executable by the processor to:
normalize, at the processor, the transformed signal; and
normalize, at the processor, the reconstructed signal.

11. The quantum system of claim 9, the memory including instructions executable by the processor to:
synthesize the input signal based on a captured signal;
determine parameters of the input signal based on the reconstructed signal.

12. The quantum system of claim 9, the memory including instructions executable by the processor to:
add quantum noise of the input signal to the input signal prior to application of the input signal to the one or more QFT circuits.

13. The quantum system of claim 9, the memory including instructions executable by the processor to:
add quantum noise of the transformed signal to the transformed signal prior to application of the transformed signal to the one or more IQFT circuits.

14. A quantum system for signal compression by peak-picking of QFT components, comprising:
a processor in communication with a memory, one or more QFT circuits, and one or more IQFT circuits, the memory including instructions executable by the processor to:
access, at the processor, an input signal;
apply the input signal to the one or more QFT circuits to obtain a transformed signal and quantum noise information associated with the input signal; and
select data for L peaks of the transformed signal;
set data of the transformed signal to zero excluding the data for L peaks; and
apply the transformed signal to the one or more IQFT circuits to obtain a reconstructed signal and quantum noise information associated with the transformed signal.

15. The quantum system of claim 14, the memory including instructions executable by the processor to:
normalize, at the processor, the transformed signal; and
normalize, at the processor, the reconstructed signal.

16. The quantum system of claim 15, the memory including instructions executable by the processor to:
synthesize the input signal based on a captured signal;
determine parameters of the input signal based on the reconstructed signal.

17. The quantum system of claim 15, the memory including instructions executable by the processor to:
add quantum noise of the input signal to the input signal prior to application of the input signal to the one or more QFT circuits.

18. The quantum system of claim 15, the memory including instructions executable by the processor to:
add quantum noise of the transformed signal to the transformed signal prior to application of the transformed signal to the one or more IQFT circuits.
